(19) United States
(12) Patent Application Publication
(10) Pub. No.: US 2025/0073760 A1
(43) Pub. Date: Mar. 6, 2025

(54) SYSTEM AND METHOD FOR CLEANING MATERIALS

(71) Applicant: SONOPROCESS TECHNOLOGIES INC., Burlington (CA)

(72) Inventor: Un Hak SEONG, Daejeon (KR)

(73) Assignee: SONOPROCESS TECHNOLOGIES INC., Burlington, ON (CA)

(21) Appl. No.: 18/819,079

(22) Filed: Aug. 29, 2024

Related U.S. Application Data
(60) Provisional application No. 63/535,735, filed on Aug. 31, 2023.

(51) Int. Cl. B08B 3/12; G01T 1/167

(52) U.S. Cl. CPC B08B 3/123; G01T 1/167

(57) ABSTRACT

There is provided a system for cleaning a material. The system may include a tank, a plurality of ultrasonic transducer disposed within the tank. The material may be placed within the tank, which may be at least partially filled with a liquid. A computing device may be configured to activate the ultrasonic transducers so as to create constructive interference which generates ultrasonic shockwaves within a target zone within the tank to dislodge contaminants from a material located in the target zone.

### CROSS-REFERENCE TO RELATED APPLICATIONS

This claims the benefit of and priority to U.S. Provisional Patent Application No. 63/535,735, filed Aug. 31, 2023, the entire contents of which are incorporated herein by reference.

### FIELD

This relates generally to systems and processes for decontaminating surface-contaminated materials, and in particular to separating particles from surfaces of materials using pulsed ultrasonic waves.

### BACKGROUND

Many methods are known for decontaminating or otherwise cleaning the surfaces of solid materials.

Typically, contaminants attached to the surface of a material are held via a number of binding forces, including electrostatic forces, Van der Waal forces, and capillary forces. Liberating such contaminants from the surface requires applying energy which exceeds these binding forces.

Some methods for decontaminating a surface may include applying kinetic energy sufficient to overcome binding forces, such as manual scrubbing, sand and/or grit blasting (whether applied manually by an operator holding a blast nozzle, or in a closed environment having a target placed therein), high-pressure washing (whether directed manually or in a closed environment where nozzle placement is controlled), and CO2/dry ice blasting. Other methods may include chemical washing (e.g. applying chemicals which create a chemical reaction with higher reaction forces than the binding energy of the contaminant). Other methods may include laser ablation (in which the substrate to which the contaminant is bound is exploded, thereby liberating both the substrate along with the contaminant).

Such methods may have numerous applications, ranging from, for example, the removal of grease from a barbeque grill, to the removal of radioactive particles from a surface. However, these methods suffer from numerous drawbacks which may render their application inefficient and impractical. It is difficult to deliver sufficient force and/or energy to small particles that are stuck in hard-to-access areas such as cracks, crevices, joints, and the like.

As such, the efficacy of the above-noted methods is heavily dependent upon the shape and size of the object being cleaned, as well as the shape and size of the environment in which the object is placed. If a target material has a complex geometry which includes features such as cracks, crevices, joints, and the like, or is more complex than a flat or slightly curved sheet, it might not be possible to guarantee that contaminants in such areas will be liberated using these methods.

Moreover, the above-noted methods may require the manual sorting and characterization of different objects prior to cleaning or decontamination because decontamination techniques may depend on the particular chemical types of the contaminants involved, in addition to the geometry of the objects. Such sorting may require manual inspection by workers, which may result in the exposure of workers to hazardous materials during such inspections.

It would be desirable for a cleaning or decontamination process which is less sensitive to the shape of the object being cleaned, less dependent on the shape and size of the environment in which the object is located, more efficient, and/or less reliant on manual labour.

### SUMMARY

According to an aspect, there is provided a system for cleaning a material, the system comprising: a tank; a plurality of ultrasonic transducers disposed proximal to said tank; a computing device operatively coupled to said plurality of ultrasonic transducers, said computing device configured to activate at least one of said ultrasonic transducers to generate a plurality of pulsed ultrasonic waves configured to interact to produce ultrasonic shockwaves within a target zone within said tank.

According to another aspect, there is provided a method of cleaning a material, the method comprising: providing a plurality of ultrasonic transducers within a tank containing liquid, said ultrasonic transducers configured to generate a plurality of pulsed ultrasonic waves configured to interact to produce shockwaves within a target zone within said tank; and transporting said material through said target zone.

Other features will become apparent from the drawings in conjunction with the following description.

### BRIEF DESCRIPTION OF DRAWINGS

In the figures which illustrate example embodiments,

FIG. 1 is a block diagram depicting an example cleaning system, in accordance with some embodiments;

FIG. 2A is a block diagram depicting components of an example pre-processing stage, in accordance with some embodiments;

FIG. 2B is a block diagram depicting components of a simplified example ultrasonic cleaning system, in accordance with some embodiments;

FIG. 2C is a block diagram depicting components of a simplified example inspection and sorting stage, in accordance with some embodiments;

FIG. 3A is a perspective view of a transport device using a screw system;

FIG. 3B is a simplified exploded diagram depicting example components of an ultrasonic cleaning system having a plurality of ultrasonic transducers proximal to a transport device;

FIG. 3C is a simplified diagram illustrating components of a system which uses a phased array configuration of transducers for creating shockwave-shaped constructive interference of pulsed ultrasonic waves;

FIG. 3D is a simplified depiction of various possible modes of operation for a phased array of transducers;

FIG. 3E is a depiction of a method of varying the target zone within a chamber by controlling a plurality of transducers via electronic and/or software controls;

FIG. 4A is a cross-sectional view of a cylindrical chamber during phased array operation;

FIG. 4B is a longitudinal view of the interior of the cylindrical chamber of FIG. 4A;

FIG. 4C is a cross-sectional view of an example cylindrical chamber during phased array operation in accordance with some embodiments;

FIG. 4D is a longitudinal cross-sectional view of the cylindrical chamber of FIG. 4C;

FIG. 5A is a cross-sectional view of a rectangular tank during phased array operation;

FIG. 5B is a longitudinal view of the interior of the rectangular tank of FIG. 5A;

FIG. 6A is a cross-sectional view of a rectangular tank having a phased array configuration of transducers on a single side of the tank;

FIG. 6B is a longitudinal view of the interior of the rectangular tank of FIG. 6A;

FIG. 7 is a simplified diagram of an example embodiment of an ultrasonic cleaning system, in accordance with some embodiments;

FIG. 8 is a block diagram depicting components of an example computing device

FIGS. 9A and 9B are schematic and cross-sectional views of an example ultrasonic cleaning device, in accordance with some embodiments; and

FIG. 10 is a diagram depicting an example ultrasonic cleaning system, in accordance with some embodiments.

### DETAILED DESCRIPTION

Some embodiments described herein relate to the use of ultrasonic cleaning systems to decontaminate solid and/or loose materials (e.g. metal, plastic, rubber, to name but a few examples). In some embodiments, the material is a liquid. In some embodiments, the material is a solid. In some embodiments, the material being decontaminated is a non-porous material. In some embodiments, systems and methods described herein may be applicable to porous materials (e.g. spent ion exchange resin, contaminated soil, and more generally materials for which contaminants are not embedded). Although some embodiments described herein relate specifically to the use of pulsed ultrasonic waves to decontaminate or remove radioactive material from the surface of a solid object, it is contemplated that some embodiments of the systems and methods described herein are applicable in many other contexts, to both solid and/or liquid materials. In some embodiments, pulsed ultrasonic waves may interact to form a shockwave.

Such other contexts may include, but are not limited to, removing grease from a barbeque grill, dishwashing operations, removing contaminants from soil, removing contaminants from ion exchange resin, cleaning dust from semiconductors, and the like. Such other contexts may include applications which relate to separating one material from another rather than removing contaminants, such as separating bitumen from sand.

The use of ultrasonic waves to clean surfaces has found application in some contexts, but traditional systems suffer from numerous drawbacks. For example, ultrasound technology has been used to remove surface contaminants from various small-scale materials (e.g. cleaning jewelry, removing oil, and the like). Generating ultrasonic waves in a liquid medium (e.g. water) typically creates cavitations (e.g. microbubbles) which implode and create shock waves. These shockwaves may deliver kinetic energy to materials nearby, and the quantum of kinetic energy may be sufficient to loosen and remove loose particles from those nearby surfaces. Thus, by submerging, for example, a piece of jewelry in water and generating ultrasonic waves, these waves may be sufficient to remove impurities from the surface of the jewelry.

In some embodiments, frequencies in the 20-40 KHz range can remove particles which are larger than 10 microns. However, in order to remove very small particles (e.g. particles less than 5 microns, between 1-5 microns, or even smaller than 1 micron), higher frequencies of ultrasound beyond the normal range of 20-40 KHz may have to be used. As an example, to remove particles which are under 1 micron, higher frequencies (e.g. in the range of 25 kHz to 400 kHz) may be necessary. In some embodiments, frequencies in the range of 1.5 MHz to 2.5 MHz may be necessary. In still other embodiments, frequencies in the range of 2 MHz may be necessary. It will be appreciated that the frequency chosen will depend on the particular application and the nature of the contaminants and associated particle sizes involved. For example, in the case of removing radioactive particles from a substrate, a frequency range of about 40 kHz to 200 kHz may be suitable.

For example, when the substrate material being cleaned 101b is very thin (e.g., if particles are being removed from the surface of a semiconductor wafer or chip (for example, a silicon wafer or chip), for example, in between fabrication steps), the energy associated with frequencies in the kHz range may be too strong and cause damage to wafer, while frequencies in the 2 MHz range may deliver less energy and may be more suitable for avoiding damaging the underlying material being cleaned. For example, a suitable frequency range for cleaning a semiconductor device could be between about 500 KHz to 2 MHz.

It will be appreciated that the upper and lower bounds of such frequency ranges are not intended to be hard cutoffs, and that frequencies substantially in that range (including frequencies slightly lower than the lower bound or slightly higher than the upper bound) may perform suitably.

At lower frequencies (e.g. 20 to 40 kHz), larger cavitations (i.e. larger air pockets) are created within a liquid, which have a relatively large shock wave energy when the bubbles implode. However, lower frequencies are not effective for removing smaller particles (e.g. radioactive particles). At higher frequencies (e.g. 400 kHz), the bubbles created by ultrasonic transducers are much smaller, which results in the corresponding implosion shock wave having a much lower energy at higher frequencies relative to lower frequencies. For example, the cavitation implosion shockwave at 25 KHz has about a thousand times more energy than a cavitation implosion shock wave at 400 KHz. This inverse relationship between intensity (or power) and frequency (e.g. density of waves) creates challenges with using ultrasonic cleaning for smaller sized particles, as it is not possible to increase the frequency of the ultrasonic waves to remove finer-sized particles without decreasing the energy delivered by the implosion shockwave. A decrease in energy would result in less kinetic energy being delivered to nearby surfaces, and therefore less kinetic energy would be available to loosen or dislodge contaminants from those surfaces.

As such, the use of ultrasonic waves alone in larger-scale applications or for fixed contaminant (as opposed to loosely bound contaminants) removal has been known to be ineffective. For example, international authorities such as the International Atomic Energy Agency have indicated that ultrasound technology cannot remove fixed (i.e. tightly bound) contaminants from the surface of an object. However, ultrasound technology has found limited use as a tool for accelerating chemical reactions in surface cleaning activities. For example, a radioactive metal submerged in an acid solution or detergent solution can benefit from ultrasonic waves to accelerate chemical reactions taking place on the surface of the object being cleaned.

Nevertheless, conventional ultrasonic cleaning systems have not previously been suitable for removing fixed (i.e. tightly bound) contaminants from an object, due to the inability to deliver sufficient energy at the appropriate frequency to a target, which stems from the inverse correlation between frequency and power for ultrasonic waves.

Some embodiments described herein may provide an ultrasonic cleaning system which is able to provide, to a target zone, increased power at the appropriate frequency combinations sufficient to dislodge various sizes of contaminant particles from a surface positioned within the target zone. In some embodiments, the ultrasonic cleaning system may combine multiple different pulsed ultrasonic waves at different frequencies and phases to create shockwaves within the target zone.

In some embodiments, the ultrasonic cleaning system comprises a particular geometrical arrangement of a plurality of ultrasonic transducers (e.g. with specific spacing and distance between certain transducers, as well as specific distances from the target zone). In some embodiments, when the plurality of transducers are activated, the geometrical arrangement of transducers may create constructive interference of pulsed ultrasonic waves to generate shockwaves in the target zone.

In some embodiments, the ultrasonic cleaning system comprises a phased array control configuration of ultrasonic transducers and an electronic controller configured to activate specific ultrasonic transducers with specific phase delays and specific timing relative to other ultrasonic transducers. In some embodiments, the phased array configuration of ultrasonic transducers may create constructive interference of pulsed ultrasonic waves to generate shockwaves in the target zone. As described further below, in some embodiments, the use of a phased array configuration of ultrasonic transducers may be capable of creating shockwaves in the target zone irrespective of the geometrical configuration of the transducers. Moreover, in some embodiments, the use of phased array control may allow for the shape and location of the target zone to be adjusted without adjusting the physical location of the ultrasonic transducers.

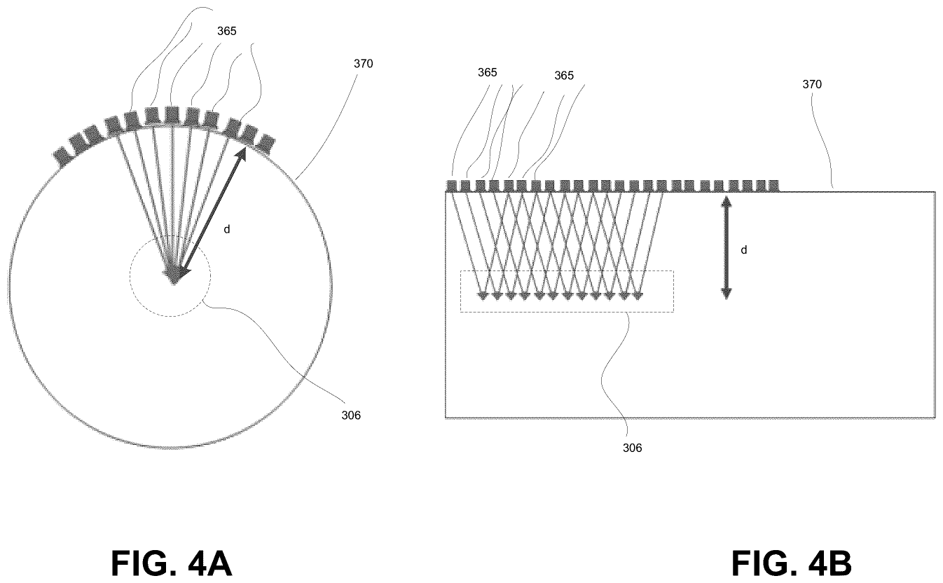

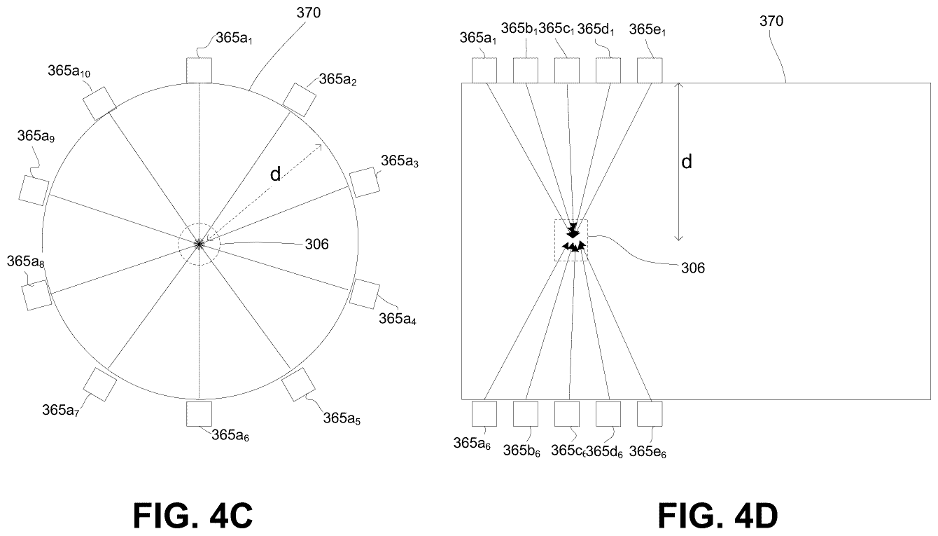

In some embodiments, the ultrasonic cleaning system comprises a geometrical arrangement of ultrasonic transducers in combination with a controller configured to provide phased array control functionality. In some embodiments, the combination of a predetermined geometrical configuration of ultrasonic transducers and the phased array control configuration may provide greater flexibility to the ultrasonic cleaning system in terms of the energy delivered to the target zone and the location of the target zone relative to systems in which one of the geometric configuration alone or phased array control alone are used (as described herein in relation to, for example, FIGS. 4A and 4B). The geometrical and phased array control transducer configurations are described in further detail below.

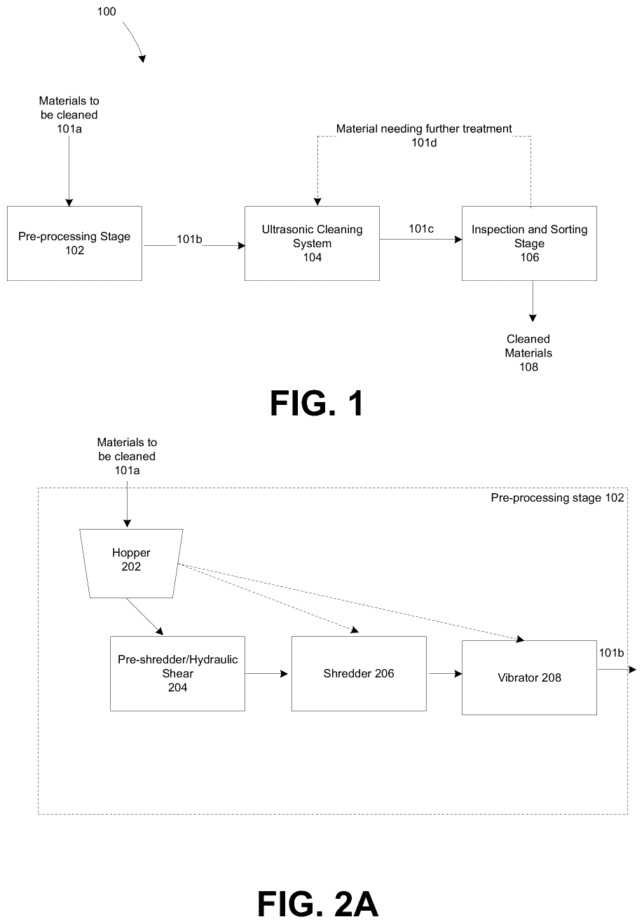

FIG. 1 is a block diagram depicting an example cleaning system 100. In this disclosure, example cleaning system 100 is described with reference to cleaning or decontaminating materials which include radioactive waste (such as, for example, materials used at nuclear power plants which become contaminated with radioactive materials over time) and semiconductors. It will be appreciated that the invention is not limited to cleaning materials which are contaminated with radioactive materials. It will be further appreciated that various treatment stages described herein are applicable to other cleaning processes which might not involve radioactive materials or different scales and sizes of objects being cleaned. Likewise, it will be appreciated that various treatment stages described herein might be optional, might not be required, or may take a different form for cleaning materials which are not contaminated with radioactive materials. As such, it is contemplated that various embodiments described herein may include combinations and permutations of stages described herein without every single combination or permutation being separately or explicitly described herein.

As depicted, materials contaminated with radioactive materials 101a may first be subjected to a pre-processing stage 102. Once pre-processing is complete, the pre-processed material 101b may then be subjected to ultrasonic cleaning system 104. Once ultrasonic treatment is complete, the treated material 101c may be moved to an inspection and sorting stage 106. Optionally, inspection and sorting stage 106 may determine that one or more treated materials 101c has not been sufficiently cleaned or decontaminated, and may divert such material needing further treatment 101d to ultrasonic cleaning system 104 for further treatment. In some embodiments, treated materials 101c may be sorted at inspection and storage stage 106, and then released as cleaned material 108.

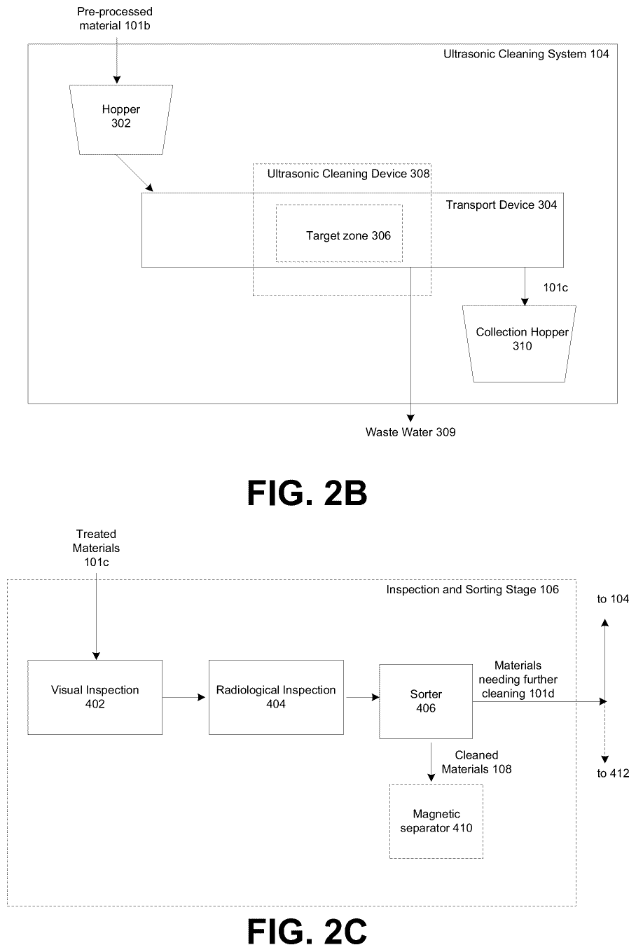

FIG. 2A is a block diagram depicting components of an example pre-processing stage 102, in accordance with some embodiments. In some embodiments, pre-processing stage 102 serves to perform at least one of reducing the size of the material to be cleaned 101a and/or converting a closed geometry of a material to be cleaned 101a to an open geometry (that is, preventing the existence of internal voids). As depicted, pre-processing stage may include one or more of hopper 202, pre-shredder 204, shredder 206, and vibrator 208. Hopper 202 may be any general purpose receptacle which acts as a container for material 101a, which typically tapers in the downward direction and is able to discharge its contents at the bottom. Hopper 202 may act to control the rate at which new materials 101a are added to subsequent stages (e.g. pre-shredder 204, shredder 206, and/or vibrator 208).

In some embodiments, hopper 202 may dispense materials 101a into pre-shredder 204. In some embodiments, a hydraulic shear may be used rather than a pre-shredder 204. In some embodiments, both a hydraulic shear and a pre-shredder 204 may be present in system 100. A pre-shredder 204 may be used to, for example, reduce and defuse material prior to the material entering shredder 206, and separate unshreddable materials. Pre-shredder 204 may also homogenize incoming material 101a, which may allow for better control of the feed rate of material to shredder 206.

In some embodiments, a hydraulic shear may be included to segment or otherwise disassemble materials having certain sizes, geometries or shapes. For example, ultrasonic cleaning requires the target to be immersed in a liquid (e.g. water, oil, acid, or the like) so that pulsed ultrasonic waves may be propagated through the liquid and to the target. Objects which have a closed geometry (e.g. crimped pipes, bolted balls, and the like) may potentially have an internal void which needs to be cut open so that all surfaces are exposed to the liquid (e.g. water). Moreover, it is beneficial for there to be space for dislodged contaminants to exit such structures.

In some embodiments, manual segmentation or disassembly of materials 101a may be performed using, for example, an oxy-acetylene torch, a band saw, or the like. An automated or semi-automated process may provide enhancements to efficiency, and in the case of radioactive materials, for reducing exposure of human workers to radiation. In some embodiments, a material 101a (e.g. a pipe) may be sheared using an automated shearing machine. Such shearing machines and pre-shredder machines are commercially available. In some embodiments, the use of one or more of waterjet cutters, laser cutters, a band saw, and the like may be automated. It will be appreciated that the particular method used for disassembly of materials may depend on the type of material being disassembled and the nature of the application. For example, it might be unsuitable to use an oxy-acetylene torch or other thermal cutting methods with materials which have been contaminated with radioactive particles (as this may cause particles previously located on the surface of the material to mix into the substrate material, resulting in removal of contaminants being more difficult and/or impossible).

As depicted in the example embodiment of FIG. 2A, the pre-shredded and/or sheared material 101a may be sent to shredder 206. Shredders 206 are commercially available devices configured to reduce the size of scrap metals to facilitate ease of handling. It is noted that it is possible that the shearing and/or shredding processes may result in pieces of segmented material 101a being pressed together, which may result in a closed geometry which may be unsuitable for ultrasonic treatment. In some embodiments, the sheared and/or shredded material 101a may be sent to a vibrator 208 (e.g. a vibration belt, a shaker, or the like) to dislodge materials that are pressed together to ensure open geometries. In some embodiments, one or more pre-processing stages may be omitted or re-arranged. For example, in some embodiments, block 204 and/or block 206 and/or block 208 may be optional. As such, in some embodiments, hopper 202 may dispense an item to ultrasonic cleaning system 104 directly. As an example, in some embodiments, shredder 206 might not be necessary (if, for example, the container or tank 370 of ultrasonic cleaning system 104 has large enough dimensions to allow a component to be submerged therein and cleaned).

One of the many challenges associated with conventional cleaning systems, and specifically with systems used to decontaminate components which have been contaminated with radioactive waste, is that the shape and size of materials 101a can vary greatly. For example, the materials 101a may include one or more of pipes, ladders, flat plates, bolts, nuts and other industrial fasteners, tools, pumps, motors, and the like. In conventional systems, materials 101a are required to be sorted, typically into similar geometries and types (e.g. pipes may be grouped together, flat sheets may be grouped together, bolts and nuts and other fasteners may be grouped together, and the like) prior to further processing.

Once the sorting and grouping (which takes significant time, labour, and exposes humans to radiation) is complete, the materials 101a may then need to be converted to open geometries (e.g. cut open) so that the inner surfaces of materials 101a can be inspected. For example, pipes need to be cut lengthwise so the inside can be exposed, mechanically joined parts (e.g. pumps and motors) may require disassembly, and the like. Such steps require further manual labour, which is inefficient, costly, requires significant space to store materials 101a, and exposes workers to radiation in the process (which may be hazardous to workers, and may also require additional workers to be swapped in as workers reach the limit for radiation exposure).

Contrastingly, system 100 includes stages (several of which are optional) which may be automated so as to reduce and/or possibly eliminate the need for workers to perform steps such as pre-sorting and disassembly of materials 101a. Instead, blocks 204, 206, 208 may expedite and/or perform various pre-processing steps without requiring workers to be present or exposed to radiation in the process.

According to some embodiments, prior to being sent to ultrasonic cleaning system 104, materials 101a and/or pre-processed materials 101b may be subjected to an optional pre-treatment stage. A pre-treatment stage may include processes for removing certain large particles or contaminants quickly (e.g. removing a sticker from a metal surface). Such pre-treatment processes may include, for example, high-pressure jet washing, tumble blasting, and the like. In some embodiments, pre-treatment may occur subsequent to pre-processing stage 102 (e.g. after the material size has been reduced and object geometry has been converted from a closed to an open geometry). In some embodiments, pre-treatment may occur after the material size has been reduced and before the material has been converted from a closed geometry to an open geometry. It will be appreciated that this disclosure describes many example embodiments which are intended as examples without being an exhaustive list of all possible permutations, and that various stages and/or steps (including, but not limited to, the pre-processing and pre-treatment stages) can be performed in different orders than the specific example embodiments described herein without departing from the spirit and scope of the invention.

Upon completion of pre-treatment and/or pre-processing 102, pre-processed materials 101b may be transported to ultrasonic cleaning system 104. In some embodiments, a conveyor belt may transport materials 101b. In some embodiments, a slurry transport system (similar to systems using the mining industry) may transport materials 101b. In some embodiments, a rotary tube may transport materials 101b. In some embodiments, a pipe with rotating screws may be used to transport materials 101b to ultrasonic cleaning system 104. In some embodiments, the pipe may be a solid pipe. In some embodiments, the pipe may be a perforated pipe or a pipe with one or more open sections. A transport pipe having one or more open or perforated sections may facilitate the penetration of ultrasonic waves through to materials 101b.

FIG. 2B is a block diagram depicting components of a simplified example ultrasonic cleaning system 104, in accordance with some embodiments. As depicted, ultrasonic cleaning system 104 may include hopper 302, transport device 304, ultrasonic cleaning device 308, and collection hopper 310. As depicted, hopper 302 may receive pre-processed material 101b. In some embodiments, pre-processed material 101b is a plurality of shredded metal objects. In some embodiments, pre-processed material includes shredded metallic objects which are contaminated with radioactive materials. In still further embodiments, material 101b may include liquid materials. In some embodiments, hopper 302 may control the rate at which pre-processed material 101b (e.g. shredded metals, or the like) is added or otherwise dispensed to transport device 304.

Transport device 304 is configured to transport materials 101b between hopper 302 and collection hopper 310. In some embodiments, transport device 304 may be a conveyor belt. In some embodiments, transport device 310 may be a pipe with rotating screws. In some embodiments, the pipe may be perforated or otherwise contain openings. While being transported between hopper 302 and collection hopper 310, materials 101 may enter a target zone 306 of ultrasonic cleaning device 308. In some embodiments, ultrasonic cleaning device 308 includes a chamber or treatment tank filled or partially filled with a liquid or other medium that can allow ultrasonic wave transmission, and a plurality of ultrasonic transducers. In some embodiments, the liquid is water. Further example configurations of ultrasonic cleaning device 308 are described in further detail below.

In the case of materials 101b which have been previously contaminated by radioactive materials, it is most frequently the case that such materials 101b are only surface-contaminated (that is, radioactive materials are on the surface of materials 101b and have not penetrated deeper into material 101b). As such, if radioactive contaminants can be removed sufficiently from the surface of these materials 101b, these materials 101c may be considered to have been decontaminated and may be “free released” (that is, removed from regulatory control without being subject to the tracking regulations which may be required in various jurisdictions for materials contaminated with radionuclides). It will be appreciated that the standard for free release will depend upon the laws and regulations of a particular jurisdiction. For example, some jurisdictions may require the remaining radioactivity of a material to be under 0.1 Bq (Becquerel) per gram of material in order to be free released. Additionally, there may be different threshold limits for different radioactive materials. For example, some jurisdictions may require certain radioisotopes such as iodine-129 to be below 0.01 Bq/g.

As an operating principle, transducers of ultrasonic cleaning device 308 are configured to generate pulsed ultrasonic waves which propagate through the liquid (e.g. water) or solid (e.g. waveguide) medium and converge within target zone 306. In some embodiments, the plurality of pulsed ultrasonic waves interacts within target zone 306 in a manner which generates shockwaves. As material 101b moves through transport device 304, material 101b may travel through target zone 306. In some embodiments, sufficient energy is delivered by the pulsed ultrasonic waves via the liquid to target zone 306 to loosen and remove surface contaminants from material 101b.

In some embodiments, the plurality of transducers is configured to combine one or more frequencies of ultrasound waves at one or more power levels and phases so as to create shockwaves at predetermined wavelengths within target zone 306 to achieve the effect of dislodging contaminants from the surface of material 101b.

In some embodiments, ultrasonic cleaning system 104 includes a geometric configuration of ultrasonic transducers configured to produce a desired combination of waves in the target zone containing material 101b. In some embodiments, ultrasonic cleaning system 104 includes an electronically controlled phased array of ultrasonic transducers configured to deliver sufficient energy to a target zone containing material 101b to remove undesired surface contamination.

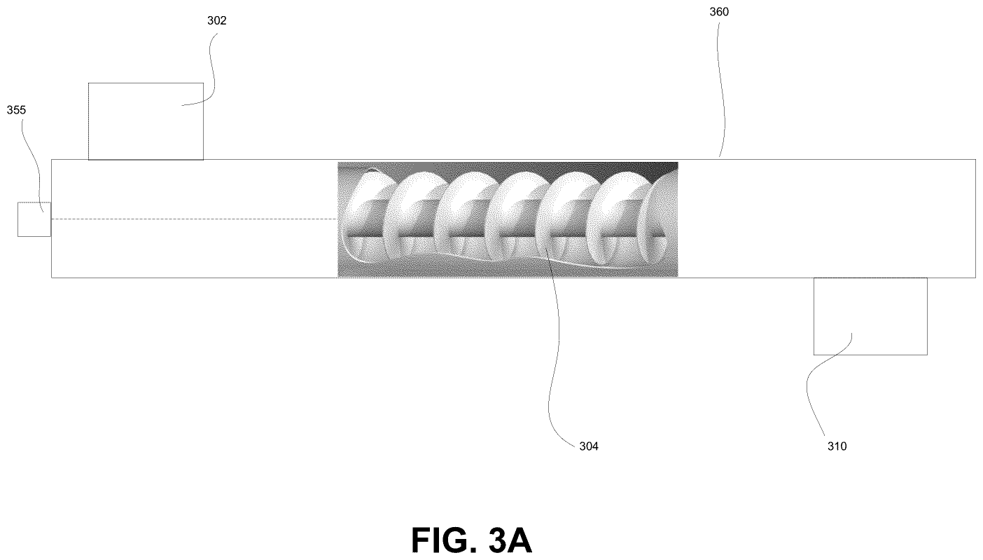

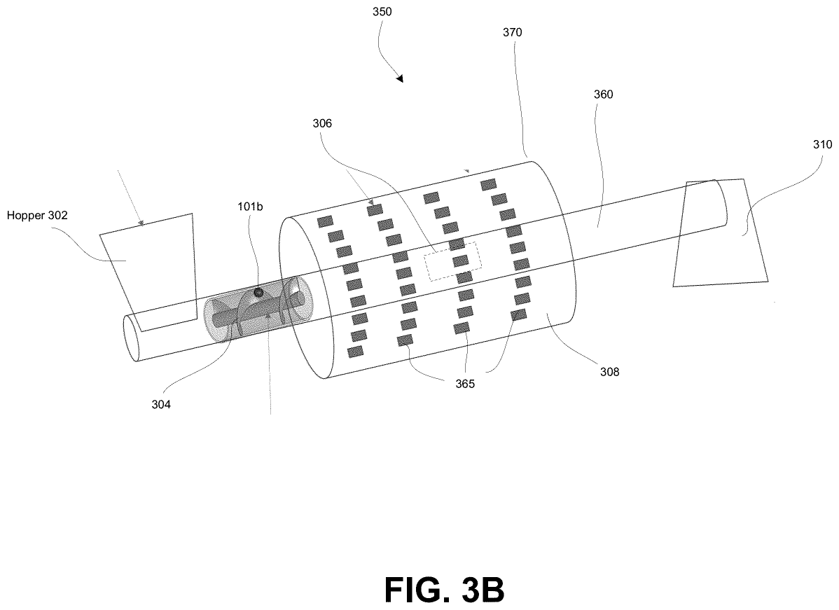

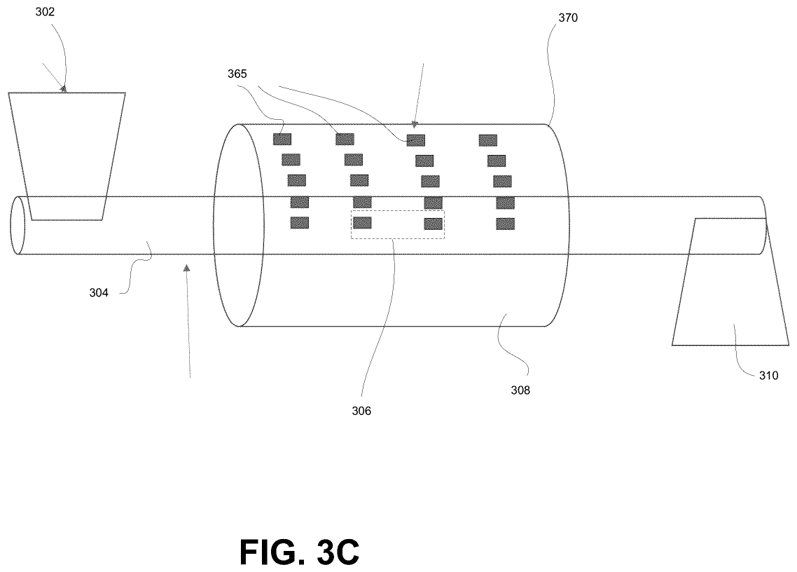

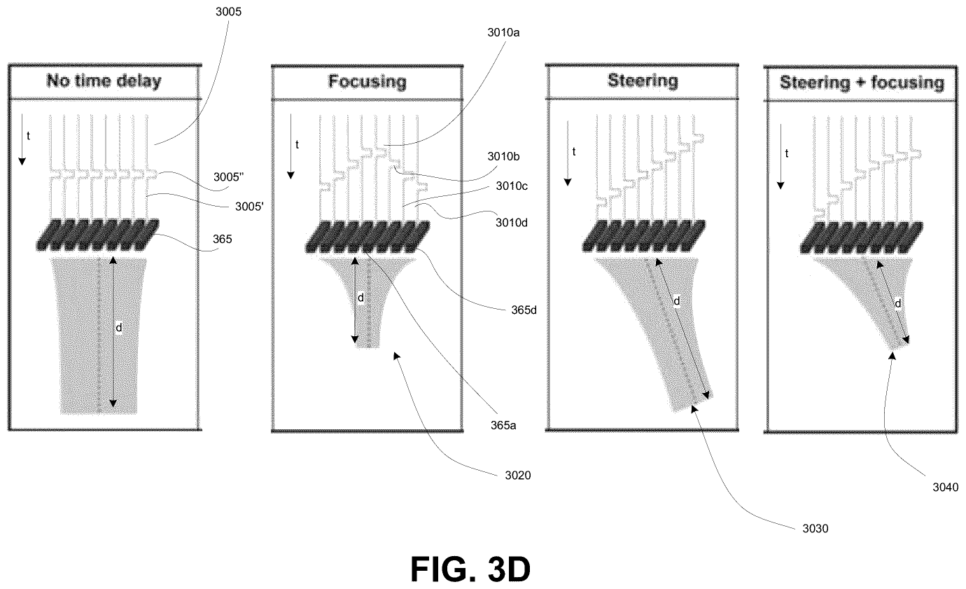

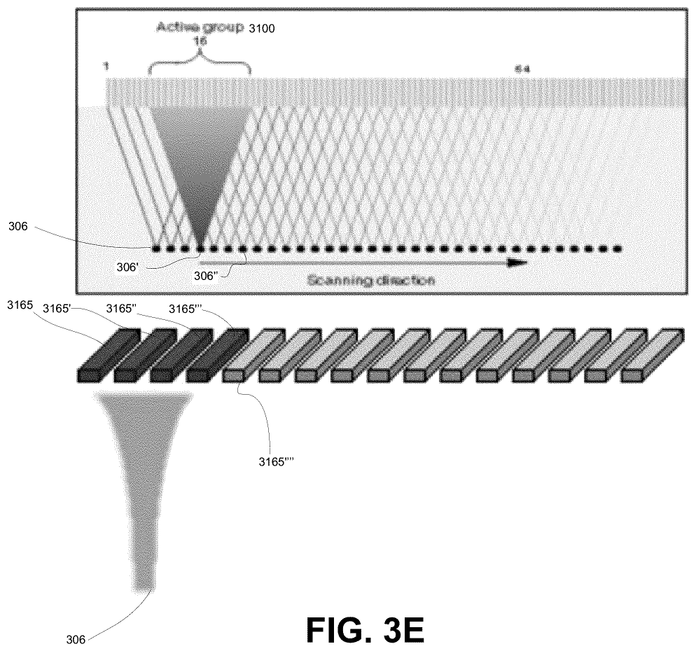

FIG. 3A is a perspective view of an example transport device 304. As depicted in the particular embodiment of FIG. 3A, the transport device 304 is a pipe or tube 360 which may be filled with liquid (e.g. water). Tube 360 may include perforations or openings, may include an open top, and/or may be a closed configuration. Materials 101b may enter transport device 304 via hopper 302. In the example embodiment depicted, transport device 304 is a screw-type conveyor which, when rotated, effects movement of material 101b along the helical ridges of the screw-type conveyor from an end proximal to hopper 302 in a direction of travel through tube 360 towards hopper 310. In some embodiments, a motor 355 may be coupled to transport device 304 to effect rotation of the screw-type conveyor. In some embodiments, transport device 304 may be rotated manually. In some embodiments, motor 355 is an electric motor. In some embodiments, motor 355 is an internal combustion engine.

In some embodiments, a plurality of ultrasonic transducers may be arranged proximal to tube 360, such that as material 101b is conveyed across tube 360 by transport device 304, material 101b is subjected to cleaning by ultrasonic cleaning device 308. FIG. 3B is a simplified exploded diagram depicting example components of an ultrasonic cleaning system 350 having a plurality of ultrasonic transducers 365 proximal to tube 360. As depicted, a chamber 370 containing water surrounds transport device 304, and a plurality of transducers 365 are arranged on chamber 370. It should be appreciated that although FIG. 3B depicts transport device 304 as including a screw-type conveyor, this is merely an example embodiment, and in other embodiments, a screw-type conveyor may be absent from such a configuration with an alternative transport device, such as a conveyor belt.

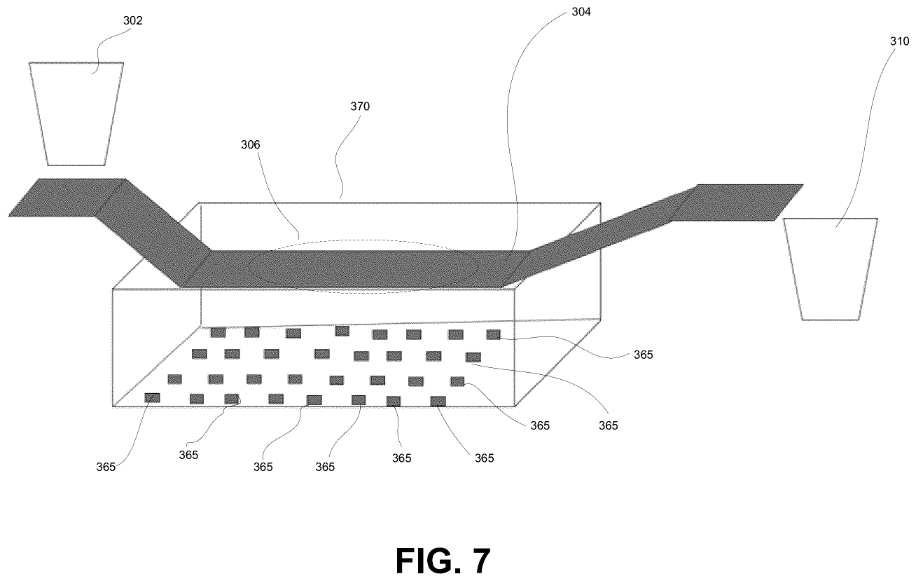

In this example embodiment, there are four rows of transducers 365 in the longitudinal direction. It should be appreciated that this is merely an example configuration, and that any number of transducers may be used. For example, as depicted in FIG. 7, transducers 365 may be arranged in any geometrical configuration which results in constructive interference of various pulsed ultrasonic waves occurring within target zone 306 to form shockwaves. As such, the example embodiment depicted in FIG. 3B (which includes four rings of transducers 365 spaced longitudinally) is merely an example, and configurations which include other geometric configurations of transducers 365 other than circumferentially spaced rings are contemplated and within the scope of the invention.

As it relates to embodiments described in, for example, FIGS. 3B, 3C and 7, in operation, transducers 365 may be activated (e.g. by a controller configured to control the activation status and frequency of each individual transducer 365) and deliver a combination of pulsed ultrasonic waves to target zone 306. In some embodiments, target zone 306 may be a relatively small volume or space in which material 101b is located (or to which material 101b is intended to be eventually located if being transported by transportation device 304). By providing a specific geometric configuration of transducers 365, system 350 is configured to generate pulsed ultrasonic waves which interact within target zone 306 in a manner resulting in the generation of shockwaves. That is, the combination of the various pulsed ultrasonic waves having different amplitudes, frequencies, power levels, and the like is selected so as to interfere constructively within target zone 306, and in so doing may deliver sufficient energy to remove contaminants from the surface of material 101b. In some embodiments, transducers 365 are arranged so as to generate shockwaves having predetermined wavelengths within the target zone 306. As noted previously, different particle sizes of contaminants may require different frequencies and wavelengths of pulsed ultrasonic waves in order for loosening and removal of those particular particles to be successful.

As depicted in FIGS. 3A and 3B, a possible configuration of system 350 is a plurality of ultrasonic transducers 365 disposed so as to surround a pipe/tube 360 (whether solid, perforated or generally having openings) in which material 101b is being transported. In other embodiments, other shapes of containers, as well as other geometric configurations of ultrasonic transducers 365 may be utilized provided the desired level of energy and frequency of shockwaves in the target zone 306 can be achieved.

In embodiments which rely only on the geometric configuration of transducers 365, in order to create shockwave-shaped constructive interference between pulsed ultrasonic waves created by the plurality of transducers 365, the distance between transducers 365 and the position of each transducer 365 is specifically chosen. Although transducers 365 are positioned in a cylindrical arrangement (or longitudinally spaced concentric rings) in FIG. 3B, it will be appreciated that virtually any geometric arrangement (e.g. spherical, multi-faceted arrangements such as hexagons, octagons, or the like) can be used, provided the spacing and positioning of each transducer is chosen so as to achieve the desired interaction of the pulsed ultrasonic waves within target zone 306 to produce shockwaves. The specific configurations for arranging transducers 365 may be determined, for example, based on computer simulations, or based on geometrical calculations. For example, a computer simulation may be based on the geometry of the transducers and the location of the targets.

In some situations, it may be challenging to control the size and location of the target zone 306 in which constructive interference is created, when relying only on the geometrical arrangement of the transducers 365. As such, the size and amount of material 101 which may be treated in a single decontamination cycle may be relatively limited when compared to embodiments which incorporate phased array control of transducers 365.

FIG. 3C is a simplified diagram illustrating components of a system 350 which uses a phased array control configuration of transducers 365 for ultrasonic cleaning device 308. In some embodiments, a phased array configuration of ultrasonic transducers may produce shockwaves composed of pulsed ultrasonic waves within target zone 306 by controlling the precise timing and activation of transducers 365. In some embodiments, an electronic controller device may be configured to control activation and/or deactivation of each individual transducer 365. In some embodiments, phased array configurations of transducers 365 may be capable of producing shockwaves of pulsed ultrasonic waves within target zone 306 independent of the geometrical configuration of transducers 365.

As such, it is possible that when using phased array control, virtually any shape or size may be used for tank 370, and virtually any arrangement of ultrasonic transducers 365 may be used in order to deliver sufficient energy to clean or decontaminate the surface of material 101b located within target zone 306. Moreover, using a phased array configuration of transducers 365 may provide a significant increase in design flexibility in terms of the design constraints of ultrasonic cleaning device 108, relative to embodiments which rely on only the geometric arrangement of transducers 365 to produce shockwaves.

In some embodiments, phased array control configurations are controlled via controlling the activation signal delay for each transducer 365. In some embodiments, the combination of generated pulsed ultrasonic waves and their interferences may be controlled by calculating the combinations of delay signals required to achieve the desired result in the desired location.

Moreover, in some embodiments, phased array configurations of transducers 365 may allow for controlling the particular location at which constructive interference and shockwave generation occurs. As such, a phased array configuration of transducers 365 can vary the location of target zone 306 by varying the combination of delay signals for each transducer. Thus, any given geometrical configuration of the transducers 365 can be taken into account by varying delay signals, and there may be a reduced need or no need for material 101b to be located in a specific, pre-determined target zone 306 in order to be cleaned. This may provide significantly improved flexibility to system 350, as irregularly shaped objects can nevertheless be targeted without requiring physical modifications to the ultrasonic cleaning device 108 itself beyond modifying the control signals which control the delay signal.

FIG. 3D is a simplified depiction of various possible modes of operation for a phased array of transducers. As depicted, control signals in the form of square waves 3005 are delivered to each transducer 365, with time t depicted. Each transducer will be de-activated during the low portion of the wave 3005′, and will activate when the signal is high 3005″ for the period of time in which the signal is high 3005″. In the diagram with no time delay, each timing signal 3005 is low 3005′ and each signal transitions to high 3005″ at the same time, resulting in a fairly straight application of pulsed ultrasonic waves with minimal interference or focusing of energy at a given depth.

In the configuration depicted as ‘Focusing’, it can be seen that there is a timing delay between each of square waves 3010d, 3010c, 3010b and 3010a. As such, transducer 365d (and the other transducer on the opposite side with the same timing signal) controlled by signal 3010d will activate before any of the transducers 365c, 365b, 365c which are controlled by signals 3010c, 3010b, 3010a, respectively. As each transducer activates with staggered timing, it can be seen that the resulting wave pattern 3020 becomes focused, with a greater amount of energy being concentrated towards the middle transducers, and with the distance of the focal locus being closer to the transducers 365. Thus, it can be seen that the location of the point at which the pulsed ultrasonic waves become focused and concentrated can be controlled through the timing and phase of the control signals.

In the configuration depicted as ‘Steering’, it can be seen that when the timing signals are staggered relative to one another in a consistent direction, the resulting wave pattern 3030 appears to change direction (i.e. is “steered”), with a greater amount of energy being concentrated towards the later side.

In the configuration depicted as ‘Steering+focusing’, it can be seen that the control signals on the left arrive first, and that the delay between each successive signal from left to right is becoming smaller, until the two right-most signals have almost the same delay. The resulting wave pattern 3040 is similar to 3030 in that a greater amount of energy is concentrated towards the later side, but the area in which the energy is concentrated is smaller (and therefore the energy is even more concentrated, relative to the ‘Steering’ configuration).

FIG. 3E is a depiction of a method of varying the target zone 306 within a chamber 370 using a phased array configuration of transducers 365. As can be seen, using the patterns of control signals described in FIG. 3D, it is possible to activate groups of transducers (e.g. 3165, 3165′, 3165″, 3165″, referred to collectively as active group 3100) using a ‘focusing’ control signal pattern to concentrate the resulting energy within target zone 306. Shortly thereafter, it is possible to activate a different grouping of adjacent transducers (e.g. 3165′, 3165″, 3165′″, 3165″″) with a similar ‘focusing’ control signal pattern. This combination of control signals can be conceptualized as a combination of the ‘focusing’ signal pattern combined with the staggered timing of the ‘scanning pattern’. As can be seen in FIG. 3E, the result of this blend of control signals is the gradual movement of target zone 306 from a first position 306, to a second position 306′, to a third position 306″, and so on. As such, by using a plurality of transducers 365, 3165, all desired areas of an object (e.g. material 101b) may be targeted with focused ultrasonic waves. In some embodiments, the energy delivered to the target zone 306, 306′, 306″ may be sufficient to loosen and/or dislodge fixed contaminants on the surface of material 101b.

In some embodiments, the amount of energy delivered to the concentrated zone 306 may be proportional to the number of transducers 365, 3165 which have been activated. Moreover, the location of the target zone 306 (both in terms of distance from the transducer, and lateral distance from the transducer, can be controlled through appropriate timing of control signals. As such, it will be appreciated that the use of phased array configurations of transducers 365, 3165 can allow for all or nearly all of the chamber 370 to be used as a potential target zone. Thus, relative to configurations which rely purely on the geometrical configuration of transducers 365 without the controlled timing of activation signals, the phased array configuration of transducers 365, 3165 allows for significantly greater flexibility and customizability of ultrasonic cleaning device 308 in terms of operational characteristics.

FIG. 4A is a cross-sectional view of a tank 370 during phased array control operation. In the example embodiment depicted in FIG. 4A, the tank 370 is embodied as a cylindrical chamber. However, it will be appreciated that in other embodiments, a tank 370 may have many other geometrical configurations (such as, for example, a rectangular prism-shaped tank) with the same principles of operation still applying.

It will be appreciated that the particular geometry for tank 370 may be chosen in accordance with a number of design considerations. For example, depending on the size of tank 370, a cylindrical tank may be less practical than a simpler geometrical shape (such as a shape having straight edges). For example, defects in the curved construction of a cylindrical tank may reduce the efficacy of ultrasonic treatment. Moreover, maintenance and repair work for a cylindrical tank may be difficult (particularly if a large cylindrical tank is filled with liquid, which presents significant weight considerations, and must be fully drained and re-filled with liquid whenever maintenance work is performed).

FIG. 4B is a longitudinal view of the interior of the tank 370 depicted in FIG. 4A. As depicted in FIG. 4A, the use of a phased array of transducers 365 may allow for the depth d of the target zone 306 to be chosen. As can be seen in FIG. 4B, the use of a phased array configuration of transducers 365 may further allow for a ‘scanning’ mode of focused waves, which may allow for the longitudinal position of target zone 306 to be selected and/or changed. In some embodiments, the size of target zone 306 may be increased or decreased. In some embodiments, the position of target zone 306 may be adjusted while maintaining the same size of target zone 306. In some embodiments, the size and the position of target zone 306 may be modified by adjusting the control signals being transmitted to transducers 365.

As will be appreciated from FIGS. 4A and 4B, the operation of the phased array of transducers does not require a particular number or geometrical positioning of transducers 365 in order to create shockwaves at the desired location. Increasing or decreasing the total number of activated transducers may result in a corresponding increase or decrease in the total energy delivered to target zone 306, but the addition or removal of transducers 365 will not prevent the creation of shockwaves in the desired location 306 (although some modification of the sequence of activation control signals sent to each individual transducer 365 may require modification as the total number of transducers and their locations changes).

In some embodiments, a particular geometrical configuration of transducers 365 may be combined with phased array control in order to enhance the amount of energy delivered to the target zone 306. For example, in the example configuration depicted in FIGS. 4C and 4D, ten (10) transducers 365a₁, . . . , 365a₁₀ are arranged around tank 370 in a particular geometric configuration, this geometric configuration alone may result in the concentration of 10× the power of a single transducer 365 within a small target zone 306. By incorporating phased array control together with this arrangement, as depicted in FIG. 4D, multiple rings of transducers spaced axially apart (e.g. a first ring containing transducers 365a₁, . . . , 365a₁₀, a second ring containing transducers 365b₁, . . . , 365b₁₀, a third ring containing transducer 365c₁, . . . , 365c₁₀, a fourth ring containing transducers 365d₁, . . . , 365d₁₀, and a fifth ring containing transducers 365e₁, . . . , 365e₁₀) may each be focused on target area 306a (e.g. at the center of the ring which includes transducers 365c₁, . . . , 365c₁₀), thereby delivering 50× the power to target zone 306a. Moreover, the dimensions and location of target zone 306a may be customized (rather than the target zone having to be in the geometric center of a ring). It will be appreciated that for the sake of simplicity, only transducers 365a₁, 365a₁₀, 365b₁, 365b₁₀, 365c₁, 365c₁₀, 365d₁, 365d₁₀, 365e₁, 365e₁₀ are shown in FIG. 4D, but that each of the 10 transducers in each of rings a, b, c, d and e are present.

It should further be noted that although transducers in FIGS. 3C and 4C are depicted as being evenly spaced circumferentially about a given cross-section of tank 370, that other embodiments need not be evenly spaced, and that the use of phased array control may allow for virtually any spacing configuration of transducers 365. Moreover, the use of 10 transducers in a given ring is merely exemplary, and in other embodiments more or fewer than 10 transducers may be used in each ring. Moreover, the same number of transducers 365 does not need to be used in each ring of transducers. Furthermore, the transducers in other embodiments need not extend fully circumferentially about the tank 370. For example, an example embodiment might include transducers 365a₁₀, 365a₁, and 365a₂ without transducers 365a₃, 365a₄, 365a₅, 365a₆, 365a₇, 365a₈, 365a₉. It will be further appreciated that this aforementioned example embodiment is merely an example and that other embodiments might include more than 3 transducers or less than 3 transducers in each axial ring 365a, 365b, 365c, and so on.

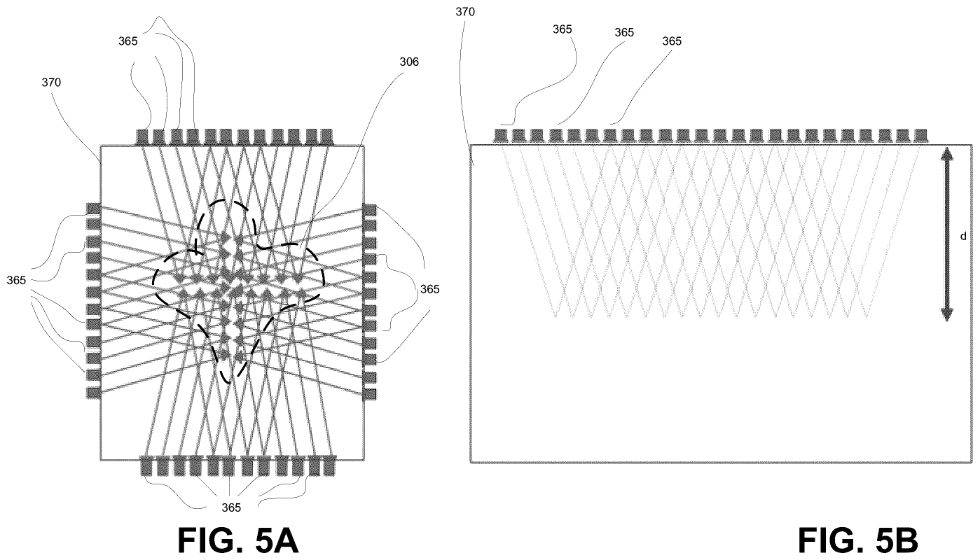

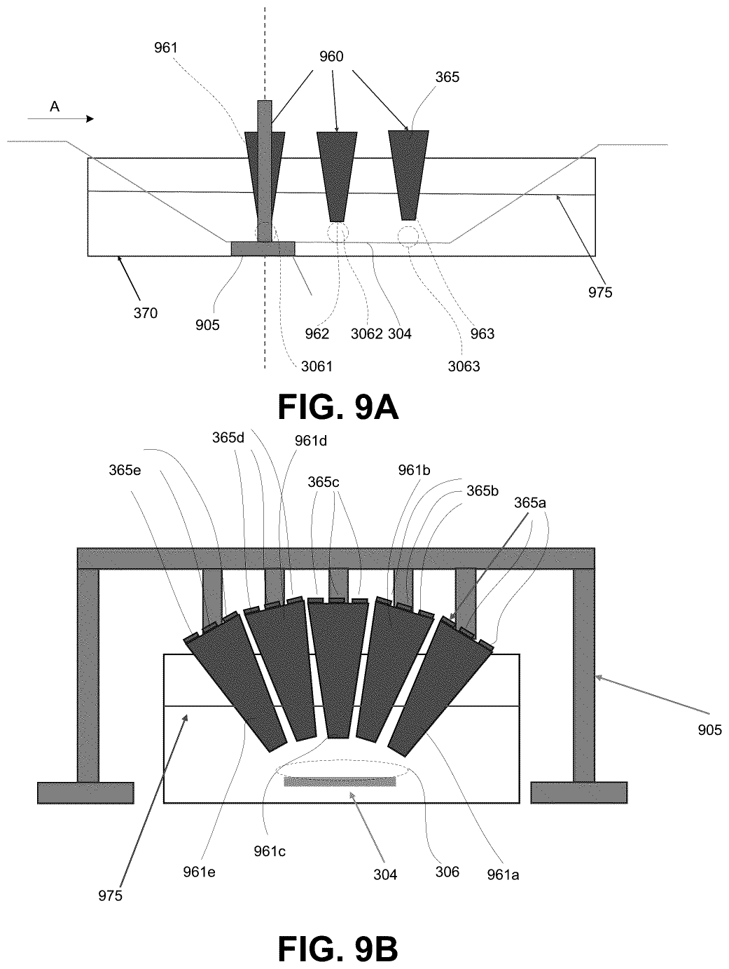

FIG. 5A is a cross-sectional view of a rectangular tank 370 during phased array operation. FIG. 5B is a longitudinal view of the interior of rectangular tank 370 of FIG. 5A. As depicted in FIG. 5A, in this example embodiment, a plurality of transducers 365 is arranged on each of the top, bottom, left and right sides of tank 370. Using a phased array configuration, it is possible to create a target zone 306 which has contributions from each set of transducers 365 on each side of the rectangular tank 370. It will be appreciated that the shape of the target zone 306 can be tailored to a specific application by adjusting the timing signals sent to each individual transducer 365. Likewise, FIG. 5B illustrates that the longitudinal length of the target zone, as well as the depth d at which constructive interference for shockwave generation occurs, can be chosen by selecting appropriate timing for each signal sent to each respective transducer 365. It will be further appreciated that in some embodiments, one or more sections of transducers may be omitted from the configuration depicted in FIG. 5A. For example, in some embodiments, transducers may be omitted from the bottom side of tank 370. In other embodiments, transducers may be omitted from the bottom and left sides of tank 370. In still other embodiments, transducers may be omitted from the bottom, left and right sides of tank 370. Moreover, in some embodiments, transducers positioned along the top side of tank 370 need not be arrange linearly and may be arranged in a partial circumferential section, as described further below in relation to FIG. 9.

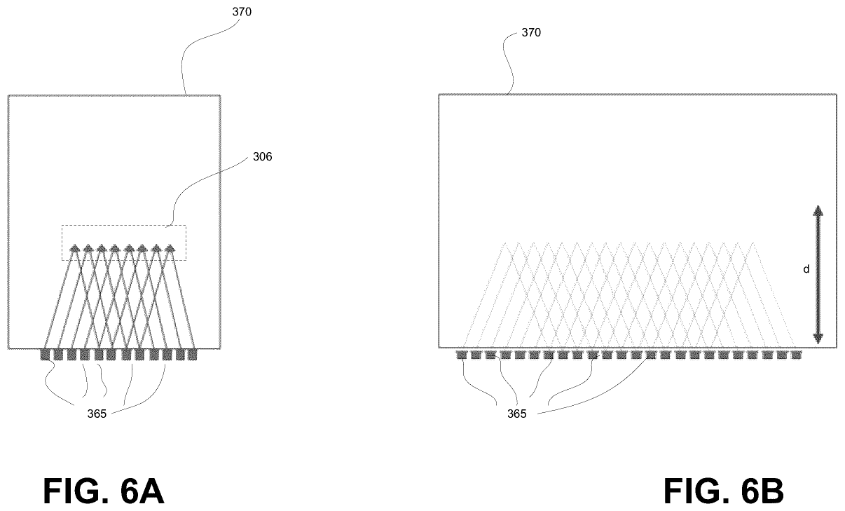

FIG. 6A is a cross-sectional view of a rectangular tank 370 having a phased array configuration of transducers 365 on one side of the tank. As depicted, by using a phased array control configuration, it is possible to deliver concentrated ultrasound energy to a target zone 306. An additional advantage of the phased array control configuration is that an existing ultrasonic cleaning system may be retrofitted with the requisite controllers and control electronics to provide phased array control functionality, thereby expanding the capabilities of a pre-existing system which previously relied on conventional ultrasound techniques (which, as noted above, are not capable of delivering sufficient energy to a target object to loosen and/or dislodge fixed contaminant particles on the surface of the target object). FIG. 6B illustrates that the depth d of the zone in which ultrasound energy is concentrated may be controlled through the appropriate configuration and timing of the control signals to transducers 365.

It will be appreciated from FIGS. 4A-6B that concentrating ultrasound energy is possible using any shape or geometry of tank 370 by using electronic control signals which are appropriately timed.

FIG. 7 is a simplified diagram of an example embodiment of an ultrasonic cleaning system 104, in accordance with some embodiments. As depicted, ultrasonic cleaning system includes a hopper 302, a tank 370 having an open top containing a liquid, a plurality of ultrasonic transducers 365 disposed within tank 370, a transport device 304, and a collection hopper 310. In the embodiment depicted, transport device 304 may be a belt conveyor which is at least partly submerged in the liquid within tank 370, so as to ensure the material 101b is submerged in the liquid while being transported. Although FIG. 7 depicts transducers 365 being disposed on only bottom side of tank 370, it is contemplated that in other embodiments, transducers 365 may be placed on a different wall (e.g. on one or more side walls), on any combination of walls, or on all walls of tank 370. In some embodiments (as depicted, for example, in FIGS. 9A and 9B), transducers 365 may be mounted to the base of a waveguide 961 which may be placed on top of conveyor 304. In some embodiments, a guard or barrier may be placed along conveyor 304 to prevent materials 101b from falling off conveyor 304 and into tank 370.

FIG. 9A is a simplified diagram of an example embodiment of an ultrasonic cleaning system 104, in accordance with some embodiments. FIG. 9B is a cross-sectional view of the ultrasonic cleaning system depicted in FIG. 9A. As depicted, ultrasonic cleaning system 104 includes a tank 370 having an open top containing a liquid having a liquid level 975, a transport device 304, and a plurality of waveguide arrays 961, 962, 963 (referred to collectively as waveguides 960) affixed to one or more support structures 905 and partially submerged below liquid level 975, each of said waveguides 960 containing a plurality of ultrasonic transducers 365. As depicted, transport device 304 may be a conveyor device which moves in direction A as shown in FIG. 9A. In some embodiments, transport device 304 may include a declined ramp which facilitates a material to be cleaned 101b in descending below the liquid level 975 of tank 370. Transport device 304 may cause material 101 to be moved towards and through target zone 306 positioned below the one or more waveguides 960a, 960b, 960c, 960d, 960e. It should be appreciated in that support structures for supporting waveguides 962 and 963 in FIG. 9A are omitted for simplicity.

As depicted in FIG. 9A, in some embodiments, there may be a plurality of stages of arrays of waveguides 961, 962, 963 arranged in the direction of travel A of transport device 304. In some embodiments, different waveguide arrays 961, 962, 963 may have distinct geometries. As such, in some embodiments, material 101b may be subjected to treatment by ultrasonic shockwaves in a plurality of target zone locations while being conveyed along transport device 304. In some embodiments, the use of distinct waveguide arrays along the direction of travel of transport device 304 may allow for portions of material 101b which were missed during a preceding array of waveguides (e.g. missed during treatment by waveguides 961 in target zone 3061) to be targeted and covered by subsequent arrays of waveguides (e.g. waveguides 962 in target zone 3062 or 963 in target zone 3063). It should be appreciated that any number of arrays of waveguides 960 is contemplated, and that 3 waveguide arrays in the axial direction in FIG. 9A is merely an example embodiment, and that more or fewer than 3 waveguide arrays is contemplated.

In still other embodiments, separate stages of waveguide arrays 961, 962, 963 may be configured to focus pulsed ultrasonic waves into a single focused target zone through the use of phased array control techniques. It will be appreciated that both types of configurations (e.g. each array of waveguides 961, 962, 963 having a separate target zones 306, and one or more arrays of waveguides 961, 962, 963 contributing to one or more combined target zones) are possible with the same physical layout of waveguides 960 and transducers 365 through the use of phased array control signals.

As depicted in FIG. 9B, an individual waveguide array 961 may include a plurality of waveguides 961a, 961b, 961c, 961d, 961e. As depicted, an individual waveguide 961a may be substantially conical in shape (with the tip clipped to a certain extent to allow ultrasonic waves to exit the end of the waveguide opposite the base). In some embodiments, waveguide 961a may include a plurality of ultrasonic transducers 365a. In some embodiments, waveguide 961b may include a plurality of ultrasonic transducers 365b. In some embodiments, waveguide 961c may include a plurality of ultrasonic transducers 365c. In some embodiments, waveguide 961d may include a plurality of ultrasonic transducers 365d. In some embodiments, waveguide 961e may include a plurality of ultrasonic transducers 365e.

Although FIG. 9B appears to depict 3 ultrasonic transducers per waveguide, it will be appreciated that this is merely an example. For example, in some embodiments, a waveguide 961a may include 100 ultrasonic transducers 365a. In some embodiments, ultrasonic transducers 365 may be disposed on the base or back of the conical waveguide. In some embodiments, waveguide 960 may be configured to facilitate propagation of pulsed ultrasonic waves created by ultrasonic transducers 365 towards target zone 306. In some embodiments, waveguide 960 may be configured to assist with the focusing the wavefront of pulsed ultrasonic waves towards the narrow end of waveguide 960 proximal to target zone 306, 3061, 3062, 3063. In some embodiments, waveguide 960 may be made of a plastic material, with a metal shell or a solid metal. In general, the material used for waveguide 960 may be selected so as to be sufficiently strong to withstand the forces and energy dissipated by the ultrasonic wavefronts generated by transducers 365. In other words, waveguide 960 should be made of a material which will not be destroyed during operation by the generated ultrasonic shockwaves.

In some embodiments, for a given waveguide, each ultrasonic transducer 365 is identical. A person skilled in the art will appreciate that when transducers and other such devices are manufactured, the existence of manufacturing tolerances may result in transducers which have some small degree of variance. For example, a 2 MHz transducer may have variance of 10% (e.g. some 2 MHz transducers may operate as low as 1.9 MHz, whereas others may operate as high as 2.1 MHZ). In some embodiments, each transducer 365a for a particular waveguide 961a may be chosen to have substantially identical performance characteristics (likewise, each transducer 365b, 365c, 365d, 365e for waveguide 961b, 961c, 961d, 961e, respectively) may have identical performance characteristics. In some embodiments, the use of identical transducers for a particular waveguide may positively enhance the wave interactions and overall performance of the wavefront generated by the transducers with that waveguide.

A person skilled in the art will appreciate that transducers can be confirmed to be identical through numerous different methods. For example, performance of transducers can be confirmed experimentally. In other embodiments, transducers which were manufactured in the same batch may be considered more likely to share identical performance characteristics. It should be further noted that the ultrasonic transducers used in separate waveguides need not be identical. For example, transducers 365e in waveguide 961e might have an operating frequency of 2 MHz, while transducers 365c in waveguide 961c might have an operating frequency of 1 MHz. In some embodiments, it might not be imperative for separate waveguides to contain ultrasonic transducers having identical performance characteristics, provided that the individual transducers within a single waveguide have substantially identical performance characteristics. In other embodiments, each transducer 365 in each waveguide 960 may have identical performance characteristics.

In other embodiments, transport device 304 may be a conveyor which is submerged in a liquid (e.g. water), thereby allowing materials 101b to be in contact with water as they are transported by transport device 304. During operation of system 104, transducers 365 are activated in accordance with a phased array control configuration, thereby allowing for the location of the target zone 306 to be selected so as to efficiently target materials 101b moving through tank 370 for treatment.

In some embodiments, the exposure of target material 101b to the energy from ultrasonic shockwaves within target zone 306 may be controlled by varying the speed of transportation of material 101b through transport device 304. For example, the speed of a conveyor belt may be reduced in order to cause target material 101b to spend a longer period of time located within target zone 306 and thus receive an increased amount of energy from the ultrasonic shockwaves relative to faster speeds. As another example, in a pipe having a screw-type conveyor, the speed of rotation of the screw may be decreased in order to cause target material 101b to spend a longer period of time located within target zone 306. Similarly, increasing the speed of transportation may correspondingly reduce the amount of time spent by target material 101b within target zone 306.

In some embodiments, the exposure of target material 101b to energy from ultrasonic shockwaves may be controlled by increasing the length of the target zone 306 (e.g. by adding additional transducers 365, or by modifying the control signals sent to each transducer so as to change the overall shape of the target zone 306) or the overall length of ultrasonic cleaning device 308. By increasing the length of the target zone 306, target material 101b may spend more time located within the target zone 306 and thus receive an increased amount of energy for dislodging surface contaminants. Similarly, reducing the length of target zone 306 may decrease the amount of energy received by surface contaminants on target object 101b.

In some embodiments, the exposure of target material 101b to energy from ultrasonic shockwaves may be controlled by a computing device (e.g., a controller). Particularly in phased array control configurations, a computing device may be configured to activate and de-activate individual ultrasonic transducers 365 and/or may adjust one or more of the amplitude, frequency, phase and/or relative timing of each individual ultrasonic transducer 365 so as to perform any of a) varying the location of target zone 306, b) varying the size of target zone 306, and c) varying the amount of energy delivered to target zone 306.

In some embodiments, the exposure of target material 101b to energy from ultrasonic shockwaves may be controlled by changing the number of ultrasonic transducers 365 in ultrasonic cleaning device 308. For example, removing (or deactivating) one or more ultrasonic transducers 365 would typically result in a decrease in the amount of energy delivered to the surface of the target material 101b in target zone 306. Likewise, adding (or activating) one more additional ultrasonic transducers 365 would typically result in an increase in the amount of energy delivered to the surface of the target material 101b in target zone 306.

In some embodiments, the shape or geometry of the material to be treated 101b can be virtually any shape provided there is an open configuration (i.e. the liquid in tank 370 must be in contact with all surfaces). When the liquid in tank 370 is in contact with all surfaces of material 101b, the energy delivered to the target zone 306 via the shockwaves created by the ultrasonic transducers may be sufficient to overcome the forces binding a contaminant (e.g. a radionuclide) to a surface of material 101b. Typically, radionuclides are bound to the surface of material 101b by a combination of Van der Waal forces, electrostatic forces, and capillary forces.

Other methods of attempting to loosen fixed particles (e.g. grit blasting, high-pressure jet washing, and the like) from the surface of a material 101b might not be effective when material 101b has a complex geometry. For example, any geometry more complex than flat sheets or slightly curve sheets may potentially have small pits, microcracks, crevices, or the like, in which very small particles of contaminants can become stuck. Such particles cannot be effectively removed using conventional methods. Advantageously, the use of ultrasonic shockwaves may deliver sufficient energy to the surface of material 101b to dislodge fixed particles, even when there are complex geometries with pits, microcracks and/or crevices involved.

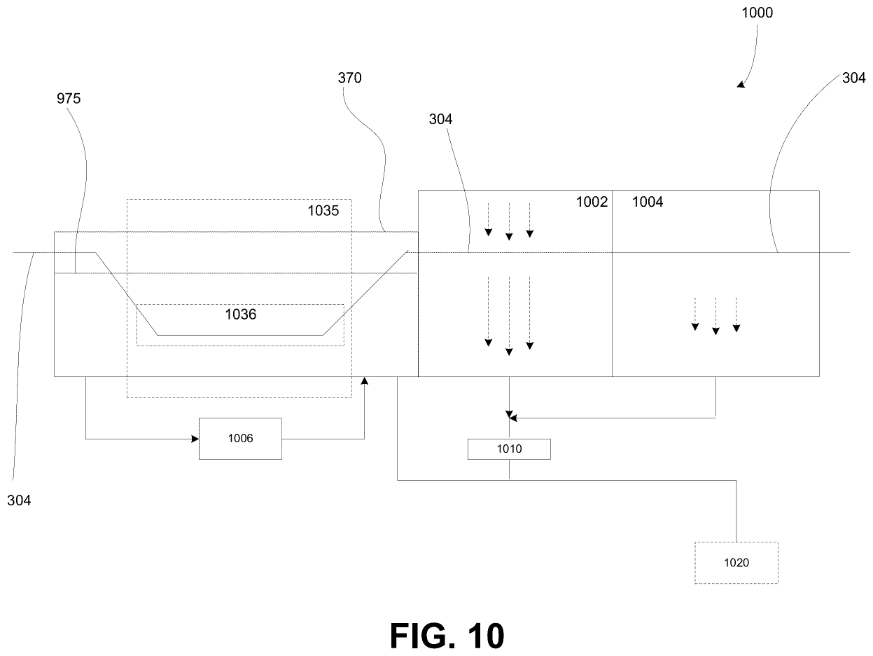

In some embodiments, as materials 101b are transported through ultrasonic cleaning device 308, contaminants will be loosened and dislodged from surfaces of materials 101b. In some embodiments, these dislodged contaminants will remain present in the liquid (e.g. water) of ultrasonic cleaning device 308. It may be desirable to perform one or more of collecting, recycling, and/or treating contaminated wastewater from ultrasonic cleaning device 308. It may be beneficial from both an economic and environmental perspective to collect, treat, and recycle wastewater as many times as is practical. FIG. 10 is a block diagram depicting components of an example ultrasonic cleaning system 1000.

As depicted, materials 101b may be transported by transport device 304 into tank 370, gradually descending below the liquid line 975 in tank 370 so as to submerge materials 101b in liquid. As the material 101b moves from left to right (as depicted in FIG. 10), it will pass through transducer mounting zone 1035 (which contains any of the various configurations of transducers 356, waveguides 960, support structures 905, and the like) and experience ultrasonic cleaning as material 101b passes through treatment zone 1036. In some embodiments, treatment zone 1036 may include one or more target zones 306, 3061, 3062, 3063.

As depicted, as contaminants are loosened and dislodged from surfaces of materials 101b, the contaminated liquid in tank 370 may be circulated through filter 1006 and transported back into tank 370. In some embodiments, reservoir liquid may be circulated continuously through filter 1006 during operation. Filtering reservoir liquid may reduce the likelihood of dislodged contaminants from re-contaminating subsequent materials 101b which enter tank 370.

After the material has passed through treatment zone 1036, transport device 304 may cause the treated material to be raised above the liquid level 975 and passed to one or more of a rinse tank 1002 and a dryer tank 1004. In some embodiments, rinse tank 1002 may include a shower which dispenses uncontaminated liquid on treated materials to further rinse off any remaining contaminants. In some embodiments, rinse tank 1002 may include submerging the treated material in a liquid.

In some embodiments, dryer tank 1004 may include a fan or blower system which may facilitate removal of moisture from treated materials. Although FIG. 10 depicts a system having both rinse tank 1002 and dryer tank 1004, it will be appreciated that other embodiments may include a rinse tank 1002 and no dryer tank and still other embodiments may include a dryer tank 1004 without a rinse tank 1002.

In some embodiments, runoff from rinse tank 1002 and/or dryer tank 1004 may be collected in waste water (or waste liquid) collection 1010. In some embodiments, waste liquid may be transported away from the system. In other embodiments, waste liquid may be treated at block 1020. In some embodiments, treatment block 1020 may include a reverse osmosis filter. In some embodiments, treatment block 1020 may include an evaporator concentrator. In some embodiments, treatment block 1020 may include an ion exchange resin filter. In some embodiments, treatment block 1020 may include both a reverse osmosis filter and an ion exchange resin filter. In some embodiments, treated liquid may be re-circulated within system 1000 as clean liquid.

In embodiments in which material 101b contains radioactive material, radionuclides may be removed and isolated from ultrasonic cleaning system 104. In some embodiments, the wastewater 309 may be filtered, which may capture non-soluble particulates. In the case of soluble contaminants (e.g. contaminants which remain dissolved in the wastewater 309 and might not be captured by a filter), wastewater 309 may be sent to an ion exchange filtration system or an evaporative concentrator. In some embodiments, the evaporative concentrator may cause the water content to be evaporated, and residual contaminants may be collected in the form of a sludge. Such evaporative wastewater treatment systems are commercially available.

In some embodiments, a facility may have a separate water treatment system. In such embodiments, wastewater 309 may be sent to the separate water treatment system without the use of filters and/or evaporative concentrators.

After travelling through ultrasonic cleaning device 308, treated material 101c may exit transport device 304 and enter inspection and sorting stage 106. In some embodiments, treated material 101c may be transported to collection hopper 310. Collection hopper 310 may be used to gather treated materials 101c and to control the rate at which treated materials are dispensed to inspection and sorting stage 106. In some embodiments, treated materials 101c may be sent directly to inspection and sorting stage 106 without the use of collection hopper 310 (e.g. continuing along a conveyor).

FIG. 2C is a block diagram depicting components of a simplified example inspection and sorting stage 106, in accordance with some embodiments. As depicted, inspection and sorting stage 106 may include one or more of visual inspection 402, radiological inspection 404, sorter 406, and magnetic separator 410. Although FIG. 2C depicts a specific implementation, it is contemplated that in other embodiments, one or more elements depicted may be omitted from or others may be added to inspection and sorting stage 106.

As depicted in FIG. 2C, treated materials 101c may be received at visual inspection block 402. In some embodiments, treated materials 101c may be inspected to see if they have been sufficiently cleaned by ultrasonic cleaning system 104. In some embodiments, visual inspection may include assessing whether visible contaminants remain on the surface of treated materials 101c. In some embodiments, visual inspection may be performed by a human operator. In some embodiments, the human operator may be physically present to inspect treated materials 101c. In some embodiments, the human operator may be in a remote location away from treated materials 101c (e.g. viewing a video feed or images taken at inspection and sorting stage 106 of treated materials 101c).

In some embodiments, a software classifier may perform visual inspection. For example, a machine learning model may be trained using training data which includes images of materials 101c which are known to have been sufficiently cleaned, and/or images of materials 101c which are known to have been insufficiently cleaned. A classifier may then receive as an input an image of a material 101c and, by applying the machine learning model, classify the material 101c as clean 108 or unclean 101d.

In some embodiments, treated materials 101c may be sent to radiological inspection block 404. At block 404, treated materials 101c may be placed within or transported through (e.g. on a conveyor belt) a radioactive material detection system. Depending on the application, any number of commercially available radioactive material detection systems may be used (e.g. systems which detect one or more of alpha, beta, and/or gamma radiation). Based on the radiation detection results, a treated material 101c may be classified as clean or unclean. For example, if the level of radiation detected exceeds a threshold amount, treated material 101c may be classified as unclean (e.g. in need of further treatment 101d). In some embodiments, a threshold level of radioactivity may be, for example, 0.1 Bq per gram of material or 10 micro Sievert per year of dose from released material. It will be understood that in some embodiments, a threshold level of radiation may be based on limits found in local laws and regulations. For example, a threshold may be set to be equal to the legal limit, or set to be equal to the legal limit with an additional buffer amount so as to ensure compliance with local regulations. In other embodiments, a threshold level of radiation may be chosen without regard to local laws and regulations. Some jurisdictions might not have a legal limit or standard for radiation, and as such a threshold limit might be chosen based on other factors. In still other embodiments, a threshold level may be chosen so as to be lower than or equal to the lowest limit worldwide. It might not be possible to use a threshold of 0, as background radiation (caused by, for example, cosmic rays, may be detected by the detector.

After visual inspection 402 and/or radiological inspection 404 are complete, treated material 101c may be sent to sorter 406. In some embodiments, sorter 406 may be configured to divert or otherwise separate materials needing further cleaning 101d from clean materials 108. In some embodiments, materials needing further cleaning 101d may be fed back (as depicted in FIG. 1) to ultrasonic cleaning system 104 for an additional round of ultrasonic cleaning.

In some embodiments, sorter 406 may be a manual system in which a human operator separates clean materials 108 from unclean materials 101d. For example, an operator may view the result of the radioactive material detection system and determine whether a given material 101c is now a clean material 108 or an unclean material 101d. In another example, an operator may determine based on a visual inspection that a given material 101c is clean 108 or unclean 101d. When material 101c is determined to be clean 108, it may be sent to a subsequent stage. When material 101c is determined to be in need of further cleaning 101d, it may be sent back to ultrasonic cleaning system 104 for additional cleaning.

In some embodiments, sorter 406 may be a computerized system configured to separate clean materials 108 from materials in need of further cleaning 101d. In some embodiments, sorter 406 may be any suitable industrial sorting system (e.g. a conveyor installed at a perpendicular angle to a conveyor carrying treated material 101c). In some embodiments, sorter 406 may include a moving gate configured to be moved to a first position (which causes materials to be diverted to a first path, such as a bin for cleaned materials 108, or optionally to a magnetic separator 410) when the material 101c is determined to be a clean material 108. In some embodiments, moving gate may be configured to be moved to a second position (which causes materials to be diverted to a second path which re-joins hopper 302 and/or transport device 304 for an additional round of cleaning) when the material 101c is determined to be in need of further cleaning 101d.

In some embodiments, sorter 406 may include a computing device 802 configured to accept inputs from a human operator. For example, when a human operator visually inspects material 101c to determine if it is sufficiently clean, the operator may enter their classification of the material into computing device 802 via a user interface. In embodiments in which visual inspection is performed by an automated classification system, the result of the classification may be processed by computing device 802 to generate a positioning command which is sent to sorter 406 (which may then cause the material 101c to be diverted in the desired direction).

In some embodiments, computing device 802 may be configured to receive a determination from radiological inspection 404. In some embodiments, when the level of radiation detected from material 101c exceeds a threshold level, computing device 802 may be configured to determine that material 101c is in need of further cleaning and send an instruction or command to sorter 406 to cause material 101c to be diverted to the path back to ultrasonic cleaning system 104. In some embodiments, when the level of radiation detected from material 101c is below a threshold level, computing device 802 may be configured to conclude that material 101c is sufficiently decontaminated and cause material 101c to be diverted to a separate path (e.g. a bin or receptacle for clean materials 108, or optionally magnetic separator 410).

In some embodiments, when it is determined that material 101c is not sufficiently clean, computing device 802 may be configured to cause sorter 406 to divert material 101d to a third path which does not return material 101d to the ultrasonic cleaning system 104. In such embodiments, unclean materials 101d may be separated into a container (e.g. a bin 412) which stores materials 101d which are known to still be contaminated. In some embodiments, separating unclean materials 101d from the cleaning process may be suitable if, for example, the material 101d has already been subjected to several rounds of ultrasonic cleaning and continues to register a level of radiation above the threshold level. In some embodiments, it may be reasonable to discard and/or classify the material as non-cleanable if a number of rounds of treatment has been insufficient to decontaminate the material.

In some embodiments, the computing device 802 may be configured to maintain a count of the number of treatments a particular material has been subjected. If the number of treatments exceeds a threshold number, computing device 802 may conclude that subjecting the material to another round of treatment is unlikely to improve the detected radiation output. In some embodiments, a threshold number of treatments may be 2 rounds. In some embodiments, the threshold number of treatments may be 3 rounds. It will be appreciated that the appropriate threshold number of treatments may be any suitable number that may be selected by the operator consistent with the particular constraints and requirements of a particular application.

In some embodiments, inspection and sorting stage 106 may include a magnetic separator 410. A magnetic separator 410 may be useful in situations where materials 101c include both ferrous and non-ferrous materials (or more generally, magnetic and non-magnetic materials). For example, when materials 101c are known to include one or more of carbon steel, stainless steel, and/or copper, a magnetic separator 410 (e.g. a magnetic drum separator, or any commercially available magnetic separation device) can be used to separate these materials. In some embodiments, separated magnetic materials may be sent to a metal recycler.

Although embodiments described above relate to automated sorting systems in which materials 101c are moved along a conveyor, it is contemplated that other embodiments may omit a conveyor or transport device and materials 101c can be placed inside in an inspection area or device for visual inspection 402 and/or radiological inspection 404 and subsequently removed after inspection is complete. Moreover, in some embodiments, a sorter 406 may be omitted and material 101c may be manually sorted depending on the result of visual inspection 402 and/or radiological inspection 404.

As noted above, it will be appreciated that in some embodiments, one or more elements depicted may be omitted from inspection and sorting stage 106 depending on the nature of the use case for the cleaning system. For example, if the material 101a is known to not have been contaminated by radioactive materials (e.g. cleaning grease from grill wires), radiological inspection block 404 might be omitted. Likewise, if the material 101a is known to have been contaminated by radioactive materials, visual inspection block 402 might be omitted (if, for example, the chief criteria for whether cleaning was sufficient relates to the levels of radiation emitted by treated material 101c, which can be measured at radiological inspection block 404). Moreover, magnetic separator 410 may be viewed as optional and may be omitted depending on the needs of the particular application. For example, if all of materials 101a are known to be metallic of either non-ferrous or ferrous type, a magnetic separator 410 might be redundant. Likewise, a magnetic separator 410 might be omitted for the purpose of simplicity.

It is contemplated that one or more stages may be omitted from example cleaning system 100 depending on the context. For example, when materials 101a include closed materials contaminated with radioactive waste, the pre-processing 102 and inspection 106 stages may be required to be more stringent, whereas when materials 101a include barbeque grills, there may be less of a need for one or more pre-processing and inspection and sorting components. A person skilled in the art will further appreciate that the sequence of certain processes described herein is merely exemplary and that it is contemplated that other permutations and orders of pre-processing and treatment are possible. Moreover, those skilled in the art will appreciate that devices and embodiments described herein may be implemented at various scales of size. For example, in some embodiments, the ultrasonic cleaning system may be sized so as to be usable on a desktop-sized device, which may be suitable, for example, in laboratory and/or institutional settings which may have a need to prepare materials for experiments to meet a certain level of cleanliness or purity. Such embodiments may be implemented at an appropriate scale based on the size of the material or object requiring cleaning or decontamination.

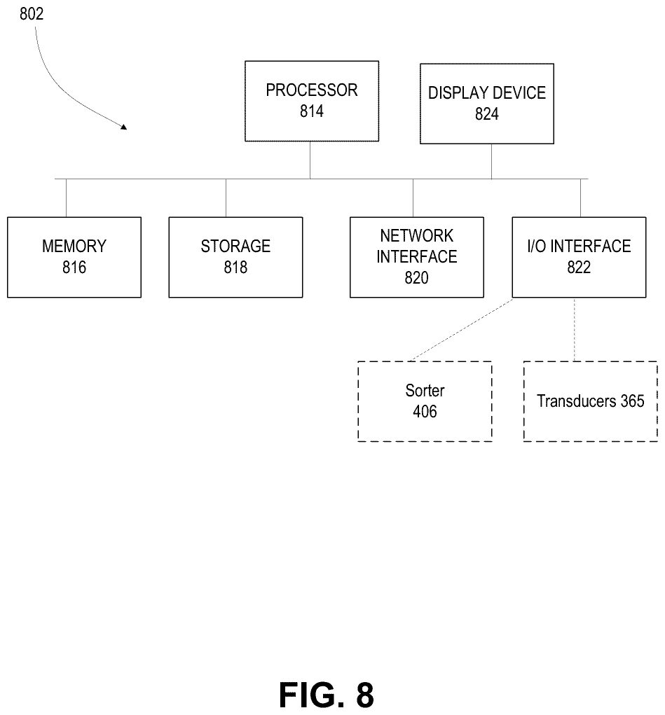

Numerous example embodiments described herein involve the use of a computing device 802. FIG. 8 is a block diagram depicting components of an example computing device. As depicted, computing device 802 includes a processor 814, memory 816, persistent storage 818, network interface 820 and input/output interface 822.

Processor 814 may be an Intel or AMD x86 or x64, PowerPC, ARM processor, or the like. Processor 814 may operate under control of software loaded in memory 816. Network interface 820 connects computing device 802 to networks. I/O interface 822 connects computing device 802 to one or more storage devices and peripherals such as keyboards, mice, USB devices, disc drives, display devices (e.g. monitors, touchscreens), as well as transducers 365, sorter 406, and other components which require electronic control and/or power.

Software may be loaded onto computing device 802 from peripheral devices or from a network. Such software may be executed using processor 814. Such software may include, for example, modules for simulating or otherwise determining the required geometrical configuration of transducers 365 in order to obtain constructive interference of pulsed ultrasonic waves to generate shockwaves within a target zone 306 of a tank 370 having a particular shape. Such software may include, for example, modules for simulating or otherwise determining the required timing signals for each individual transducer 365 in a phased array control configuration, so as to obtain the desired resulting interaction between ultrasonic shockwaves and a material 101b placed within or travelling through ultrasonic cleaning device 308.

Of course, the above described embodiments are intended to be illustrative only and in no way limiting. The described embodiments are susceptible to many modifications of form, arrangement of parts, details and order of operation. Moreover, combinations and permutations of various embodiments are contemplated and within the scope of the invention. The invention is intended to encompass all such modification within its scope, as defined by the claims.

What is claimed is:

1. A system for cleaning a material, the system comprising:
a tank;
a plurality of ultrasonic transducers disposed proximal to said tank;
a computing device operatively coupled to said plurality of ultrasonic transducers, said computing device configured to activate at least one of said ultrasonic transducers to generate a plurality of pulsed ultrasonic waves configured to interact to produce ultrasonic shockwaves within a target zone within said tank.

2. The system of claim 1, wherein the computing device is configured to activate each of said at least one of said ultrasonic transducers at a same time to generate said pulsed ultrasonic waves, and wherein said shockwaves result from constructive interference caused by a geometric arrangement of said activated ultrasonic transducers.

3. The system of claim 1, wherein the computing device is configured to generate a plurality of activation signals for each of said at least one of said ultrasonic transducers so as to produce said shockwaves within said target zone.

4. The system of claim 3, wherein at least a first activation signal and a second activation signal of said activation signals are phase delayed.

5. The system of claim 1, wherein a first set of said plurality of ultrasonic transducers are disposed on a first waveguide.

6. The system of claim 5, wherein a second set of said plurality of ultrasonic transducers is disposed on a second waveguide.

7. The system of claim 5, wherein said first set of ultrasonic transducers is disposed on a back surface of said first waveguide.

8. The system of claim 5, wherein said first waveguide functions as an energy transfer medium.

9. The system of claim 1, further comprising a transport device configured to transport the material through said target zone.

10. The system of claim 1, wherein said material includes radioactive particles on surfaces.

11. The system of claim 1, wherein said material is placed within said target zone while said at least one of said ultrasonic transducers are activated to produce a treated material.

12. The system of claim 11, wherein said treated material is transported to an inspection block, said inspection block configured to detect a level of radiation emitted by said treated material and determine, based on said detected level of radiation, whether said treated material is a clean material.

13. The system of claim 12, wherein said treated material is returned to said target zone when said level of detected radiation exceeds a threshold level of radiation.

14. The system of claim 1, wherein said plurality of ultrasonic transducers is configured to operate at a range of about 40 kHz to 200 KHz.

15. The system of claim 1, wherein said plurality of ultrasonic transducers is configured to operate at a range of about 500 kHz to 2 MHz.

16. The system of claim 1, wherein said tank comprises an outlet port for removing contaminated liquid.

17. The system of claim 9, wherein said transport device comprises a conveyor configured to cause a material to descend beneath a liquid level of said tank.

18. The system of claim 1, further comprising a support structure having a first set of one or more waveguides disposed thereon, each of said waveguides in said first set of waveguides comprising a plurality of ultrasonic transducers.

19. The system of claim 18, wherein said one or more waveguides of said first set are conical waveguides.

20. The system of claim 18, wherein said one or more waveguides of said first set are oriented to produce ultrasonic shockwaves in the path of movement of said transport device.

21. The system of claim 18, further comprising a second set of one or more waveguides comprising a second plurality of ultrasonic transducers, said second set of one or more ultrasonic waveguides being positioned downstream to said first set of waveguides with respect to a direction of transport of said transport device.

22. The system of claim 21, wherein said second set of waveguides has a distinct geometrical configuration from said first set of waveguides.

23. A method of cleaning a material, the method comprising:
providing a plurality of ultrasonic transducers within a tank containing liquid, said ultrasonic transducers configured to generate a plurality of pulsed ultrasonic waves configured to interact to produce shockwaves within a target zone within said tank; and
transporting said material through said target zone.
